(19) United States
(12) Patent Application Publication
(10) Pub. No.: US 2010/0139598 A1
(43) Pub. Date: Jun. 10, 2010

(54) METHOD OF INCREASING THE COMBUSTION EFFICIENCY OF AN INTERNAL COMBUSTION ENGINE

(76) Inventor: WEI HUA WANG, TAIPEI COUNTY (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/704,018

(22) Filed: Feb. 11, 2010

Related U.S. Application Data
(63) Continuation-in-part of application No. 12/219,172, filed on Jul. 17, 2008.

(51) Int. Cl. F02B 43/00

(52) U.S. Cl. 123/1 A

(57) ABSTRACT

In a method of increasing the combustion efficiency of a gasoline/diesel internal combustion engine for vehicles, vessels, aircraft, generators, etc., an adequate amount of additive is added to and mixed with gasoline/diesel fuel. The additive includes a plurality of highly electrically and thermally conductive carbon nanocapsules of a hollow polyhedral carbon cluster material having a size from a few to several decades of nanometers. The carbon nanocapsules attach to all gasoline molecular groups or diesel molecules. When the gasoline or diesel fuel is released into a combustion chamber of the internal combustion engine and ignited to burn, the carbon nanocapsules are electrically or thermally induced and release energy for all the gasoline molecular groups or diesel molecules being attached by the carbon nanocapsules to burn synchronously and uniformly. Thus, the problems of downward inclined temperature gradient, incomplete combustion, and carbon deposition in the internal combustion engine can be avoided.

### REFERENCE TO RELATED APPLICATIONS

This Application is being filed as a Continuation-in-Part application Ser. No. 12/219,172, filed 17 Jul. 2008, currently pending.

### FIELD OF THE INVENTION

The present invention relates to a method of increasing the combustion efficiency of an internal combustion engine, and more particularly to a method of using carbon nanocapsules to assist gasoline fuel or diesel fuel to burn completely in an internal combustion engine, so as to increase the combustion efficiency of the internal combustion engine as well as achieve the purposes of fuel saving and environmental protection.

### BACKGROUND OF THE INVENTION

It is known vehicles using a diesel engine or a gasoline engine currently consume the largest part of the mineralized oil energy in the world, and the emission of HC, CO, NOₓ, etc. from these vehicle engines due to incomplete combustion of gasoline fuel or diesel fuel thereof forms one of the main factors of global greenhouse effect and climate warming. The extent of reduction of engine combustion efficiency caused by incomplete combustion of fuel in the engine and aged engine parts can be as high as 8 to 48%. Among others, carbon deposition in the engine due to incomplete combustion of fuel in the combustion chamber of the engine is the most common key factor that brings to the reduced combustion efficiency, and generally results in 11%-36% of combustion efficiency reduction. Energy loss and emission of incompletely burned waste gases become worse and worse when the above problems of incomplete combustion and reduced combustion efficiency repeatedly and cyclically occur, resulting in serious environmental pollution and waste of fuel energy.

FIG. 1 shows the general principle of combustion in a car engine using gasoline as the fuel thereof. When the gasoline fuel is released from a fuel supply 11 of the car engine into a combustion chamber thereof, molecular groups 12 of the gasoline are atomized. Meanwhile, a spark plug in the car engine ignition system produces sparks by way of high-voltage discharge to ignite the front atomized, gasoline molecular groups 12 located closest to the sparks produced in the high-voltage discharge. Then, the sparks diffuse to sequentially ignite remaining gasoline molecular groups 12 located at rear positions. However, when the performance of the spark plug gradually lowers or reduces, not all the gasoline molecular groups 12 in the combustion chamber of the engine can be ignited at one time. Since the discharge sparks fail to reach at the gasoline molecular groups 12 located at rear positions in the combustion chamber of the engine, a downward inclined ignition temperature gradient in the combustion chamber tends to occur. When the combustion chamber of the engine has some areas lower than 500° C. in temperature, gasoline molecular groups 12 in these areas would be incompletely burnt to result in carbon deposit 13 in the engine.

FIG. 2 shows the general principle of combustion in a car engine using diesel oil as the fuel thereof. When the diesel fuel is released from a fuel supply 21 of the car engine into a combustion chamber of the car engine, molecules 22 of the diesel fuel are atomized into very fine molecules. Heat in the high-pressure and high-temperature combustion chamber diffuses and is transferred to the atomized diesel molecules 22, so that all the diesel molecules 22 gradually reach at their self-combustion temperature to burn. However, since the heat transfer is incomplete in rear positions in the combustion chamber of the engine, a downward inclined temperature gradient would occur at the rear positions. When the temperature in the rear positions in combustion chamber of the engine is lower than 500° C., diesel molecules 22 in these areas would be incompletely burnt to result in carbon deposit 23 in the engine.

It is therefore tried by the inventor to develop a method to ensure complete combustion in the internal combustion engine.

### SUMMARY OF THE INVENTION

A primary object of the present invention is to provide a method of increasing the combustion efficiency of an internal combustion engine, so that oil fuel in the internal combustion engine can be burnt in an upgraded combustion efficiency to achieve the purpose of saving fuel and environmental protection.

To achieve the above and other objects, the method of increasing the combustion efficiency of an internal combustion engine according to the present invention is characterized by adding and mixing an adequate amount of additive with an oil fuel used in the internal combustion engine; and the additive includes a plurality of highly electrically and thermally conductive carbon nanocapsules. When the additive is added to and mixed with a gasoline fuel, the carbon nanocapsules will attach to molecular groups of the gasoline fuel. When the gasoline fuel molecular groups attached by the carbon nanocapsules are released into a combustion chamber of a high-voltage discharge ignition type internal combustion engine, the carbon nanocapsules, due to their excellent electrically and thermally conductive character, are quickly induced by an electric energy released by a spark plug in the engine ignition system of a car through high-voltage electric discharge, and transfer the induced electric energy to all the gasoline fuel molecular groups, bringing the gasoline fuel molecular groups to be ignited at the same time and burnt uniformly. And, when the additive is added to and mixed with a diesel fuel, the carbon nanocapsules will attach to molecules of the diesel fuel. When the diesel fuel molecules attached by the carbon nanocapsules are released into a high-temperature and high-pressure combustion chamber of an internal combustion engine, the carbon nanocapsules, due to their highly thermally conductive character, can quickly and uniformly transfer the high thermal energy to all the diesel fuel molecules for the latter to reach at their self-combustion temperature and burn. Thus, with the method of the present invention, gasoline and diesel oil can be completely burnt without producing carbon deposition in the internal combustion engine.

In the method of the present invention for increasing the combustion efficiency of an internal combustion engine, the carbon nanocapsules forming the additive mixed with the oil fuel of the internal combustion engine are of a hollow polyhedral carbon cluster material, and have a size from a few to several decades of nanometers (10⁻⁹ meters). And, the carbon nanocapsules can be produced using the method disclosed in U.S. Pat. No. 7,156,958.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual view showing the principle of combustion of conventional gasoline fuel in an engine combustion chamber;

FIG. 2 is a conceptual view showing the principle of combustion of conventional diesel fuel in an engine combustion chamber;

FIG. 3 is a conceptual view showing the principle of combustion of carbon nanocapsules and gasoline molecular groups in an engine combustion chamber according to the method of the present invention; and

FIG. 4 is a conceptual view showing the principle of combustion of carbon nanocapsules and diesel fuel molecules in an engine combustion chamber according to the method of the present invention.

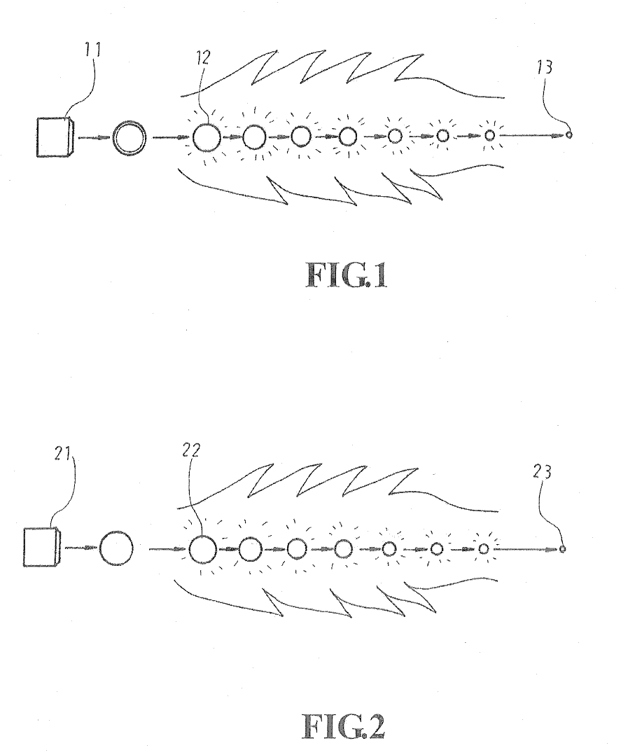

### DETAILED DESCRIPTION OF THE PREFERRED EMBODIMENTS

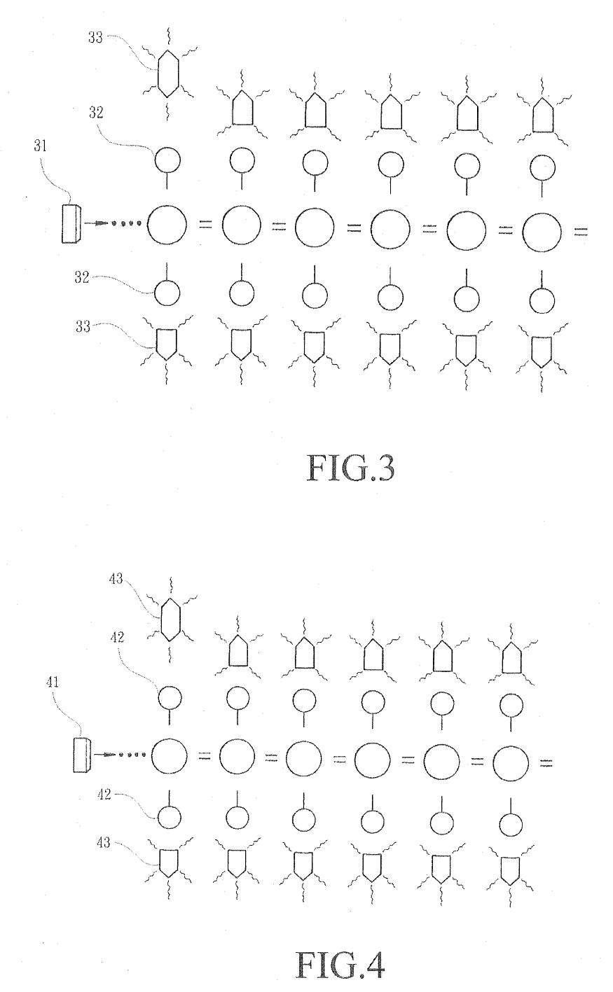

Please refer to FIG. 3. In a method of the present invention for increasing the combustion efficiency of an internal combustion engine, an adequate amount of additive is added to and mixed with an oil fuel used in the internal combustion engine. The additive includes a plurality of highly electrically and thermally conductive carbon nanocapsules of a hollow polyhedral carbon cluster material having a size from a few to several decades of nanometers (10⁻⁹ meters). The carbon nanocapsules are able to attach to gasoline molecular groups and diesel fuel molecules. Since the carbon nanocapsules have the functions of rapidly and evenly transferring electric energy and heat, all gasoline molecular groups or all diesel molecules in the combustion chamber of the internal combustion engine can be quickly ignited by induced electric energy or thermal energy of the carbon nanocapsules to thereby achieve the effect of complete combustion of oil fuel in the internal combustion engine. When the method of the present invention is applied to an internal combustion engine using gasoline as the fuel thereof for achieving the purpose of complete combustion, the following steps are included:
(1) Add and mix an adequate amount of additive with the gasoline fuel for the internal combustion engine; wherein the additive includes a plurality of highly electrically and thermally conductive carbon nanocapsules 33 of a hollow polyhedral carbon cluster material having a size from a few to several decades of nanometers (10⁻⁹ meters);
(2) Allow the carbon nanocapsules 33 to attach to a plurality of molecular groups 32 of the gasoline fuel;
(3) Release the gasoline fuel from a fuel supply 31 into a combustion chamber of the internal combustion engine, so that the molecular groups 32 of the gasoline fuel are atomized; and
(4) The carbon nanocapsules 33, due to their excellent electrically inductive character, can be quickly induced by an instantaneous high voltage released by a spark plug in a car engine ignition system through high-voltage electric discharge. As a result, all the highly electrically conductive carbon nanocapsules 33 have energy level change and release energy to ignite all the gasoline molecular groups 32 at the same time. That is, all the gasoline molecular groups 32 are not subject to time difference in heat transfer and diffusion and can be burnt uniformly at the same time, and carbon deposition in the engine due to incomplete combustion is avoided.

Please refer to FIG. 4. When the method of the present invention is applied to an internal combustion engine using diesel oil as the fuel thereof for achieving the purpose of complete combustion, the following steps are included:
(1) Add and mix an adequate amount of additive with the diesel fuel for the internal combustion engine; wherein the additive includes a plurality of highly electrically and thermally conductive carbon nanocapsules 43 of a hollow polyhedral carbon cluster material having a size from a few to several decades of nanometers (10⁻⁹ meters);
(2) Allow the carbon nanocapsules 43 to attach to a plurality of diesel molecules 42 of the diesel fuel;
(3) Release the diesel fuel from a fuel supply 41 into a combustion chamber of the internal combustion engine, so that the diesel molecules 42 of the diesel fuel are atomized; and
(4) The highly thermally inductive carbon nanocapsules 43 with super-high heat conductivity attach to the diesel molecules 42 entered the combustion chamber of the internal combustion engine, in which highly compressed hot air of from about 500° C. to about 800° C. is filled, so that heat energy can be quickly transferred from the hot air via the carbon nanocapsules 43 to all the diesel molecules 42, enabling the diesel molecules 42 to synchronously, quickly, and uniformly reach at a self-combustion temperature thereof to achieve the effect of complete combustion without forming any carbon deposit.

According to the above description, the method of the present invention provides at least the following advantages;
(1) Since the oil fuel is completely burned in the internal combustion engine, fuel loss due to incomplete combustion can be reduced by 11-36% with an average value of 25%.
(2) The internal combustion engine can have increased power output and extended service life to thereby reduce the maintenance cost thereof.
(3) Due to the perfect complete combustion reaction, the emission of various kinds of greenhouse gases, including HC, CO, NOₓ, etc., can be largely reduced with the exhaust emission reduction efficiency being upgraded by 37% to 70%.
(4) Different tangible and intangible economical benefits, such as lowered fuel consumption, extended usable years of mineralized oil resources, and extended time allowing for exploitation of other alternative energy resources, could be achieved.

Moreover, with the method of increasing the combustion efficiency of an internal combustion engine according to the present invention, it is possible to effectively suppress the greenhouse effect that results in the disaster of global warming. Therefore, the method of the present invention is novel and practical for use.

What is claimed is:

1. A method of increasing combustion efficiency of internal combustion engine, comprising the steps of:
adding and mixing an adequate amount of additive with an oil fuel for use with an internal combustion engine; wherein the additive includes a plurality of highly electrically and thermally conductive carbon nanocapsules of a hollow polyhedral carbon cluster material having a size from a few to several decades of nanometers (10⁻⁹ meters);
allowing the carbon nanocapsules to attach to all molecules of the oil fuel; and
releasing the oil fuel with the carbon nanocapsules attached thereto into a combustion chamber of the internal combustion engine, so that the carbon nanocapsules are induced by and transfer electric energy or thermal energy in the combustion chamber, and release energy to ignite all the oil fuel molecules being attached by the carbon nanocapsules, bringing all the oil fuel molecules to burn synchronously and uniformly.

2. The method of increasing combustion efficiency of internal combustion engine as claimed in claim 1, wherein the additive mixed with the oil fuel for the internal combustion engine includes a plurality of hollow carbon nanocapsules.
